(19) United States
(12) Patent Application Publication
(10) Pub. No.: US 2006/0001546 A1
(43) Pub. Date: Jan. 5, 2006

(54) Sensor for determining measured variables which are suitable for controlling an air-conditioning system and other apparatuses which influence the climate of an area

(76) Inventors: Peter Biber, Regensburg (DE); Markus Gilch, Mauern (DE); Stephan Heinrich, Regensburg (DE); Andreas Ott, Steinsberg (DE)

Correspondence Address: Martin A. Farber, 866 United Nations Plaza, Suite 473, New York, NY, 10017, US

(21) Appl. No.: 11/102,469

(22) Filed: Apr. 8, 2005

(30) Foreign Application Priority Data
Jul. 5, 2004 (DE) 10 2004 023 156.7

(51) Int. Cl. G01W 1/02; F24F 11/00

(52) U.S. Cl. 340/584; 340/425.5; 340/600

(57) ABSTRACT

Sensor for determining measured variables which are suitable for controlling an air-conditioning system and other apparatuses which influence the climate of an area, including a motor vehicle, has a single sensor housing and a printed circuit board which is equipped with sensor elements for determining the measured variables and with electronic components for processing electrical signals produced by the sensor elements, as a function of the measured variables. In the sensor, at least one light-sensitive sensor element and one gas-sensitive sensor element are arranged in the single sensor housing.

### DESCRIPTION

Sensor for determining measured variables which are suitable for controlling an air-conditioning system and other apparatuses which influence the climate of an area

The invention relates to a sensor for determining measured variables which are suitable for controlling an air-conditioning system and other apparatuses which influence the climate of an area, in particular for arrangement in a motor vehicle, having a single sensor housing and a printed circuit board which is equipped with sensor elements for determining the measured variables and with electronic components for processing the electrical signals, which are produced by the sensor elements, as a function of the measured variables.

Air-conditioning systems in modern vehicles have the ability to selectively control the temperature of two or more zones in the interior of a vehicle and thus to individually satisfy the comfort requirements of all of the occupants. In addition to the absolute interior temperature, the intensity and the angle of the incident sunlight also play an important role in the temperature felt by the occupants. A first occupant who is sitting on a side of the vehicle on which the sun is not shining may well find a temperature which is constant throughout the entire interior of a vehicle to be pleasant, whereas a second occupant of the vehicle who is sitting on a side on which the sun is shining may find this temperature unpleasantly high. In the case of the direct radiation of heat, the interior temperature should accordingly be lowered on the side of the motor vehicle on which the sun is shining so that a pleasant subjective heat sensation is set for the occupant sitting there. For this purpose, a sensor is needed which measures the radiant intensity, in the decisive infrared spectral range in the band of 800 to 1100 nm, in or at the interior of the vehicle. A sensor for determining the angle of incidence and intensity of solar radiation is known from patent specification U.S. Pat. No. 6,297,740 B1. According to U.S. Pat. No. 6,297,740, the sensor is arranged on or in the surface of an instrument panel of a motor vehicle. The sensor has an input window which allows the radiation to pass to photodiodes through channels of a component. This component has four channels which direct the sun's rays to four light-sensitive sensors. It is thus possible to detect the angle of incidence and the intensity of the solar radiation. Other than the angle of incidence and intensity of the solar radiation, this sensor cannot detect any measured variables which are suitable for controlling an air-conditioning system and other apparatuses which influence the climate of an area.

The object of the present invention is to provide a sensor with which all the relevant measured variables which are suitable for controlling an air-conditioning system and other apparatus which influence the climate of an area can be detected. This sensor should be cost-effective to manufacture and suitable for mass production.

According to the invention, the object is achieved in that at least one light-sensitive sensor element and one gas-sensitive sensor element are arranged in a single sensor housing.

The sensor is able to detect both the angle of incidence and the intensity of the solar radiation and also the pollutant gases present in the ambient air due to at least one light-sensitive and at least one gas-sensitive sensor element being arranged in a single sensor housing. The electronics which are arranged on the printed circuit board of the sensor can process the signals from the light-sensitive and the gas-sensitive sensor elements, resulting in a considerable reduction in circuit complexity. This reduced circuit complexity means that the combined sensor for determining measured variables which are suitable for controlling an air-conditioning system and other apparatuses which influence the climate of an area can be manufactured in a cost-effective manner, and potential sources of faults are eliminated since there is also always an additional potential for faults each time electronic components are additionally connected. The integration of the light- and gas-sensor system in a single sensor housing requires relatively little outlay on materials, and this is a decisive advantage for use of the sensor in motor vehicles, specifically in terms of mass production. Furthermore, the installation of a single sensor for determining a multiplicity of measured variables is significantly more simple for the automobile manufacturer than is the installation of a plurality of sensors which have to be individually positioned, fixed and wired in the vehicle and as a result ultimately increase the weight of the vehicle, the manufacturing costs and the probability of faults.

In one development, a moisture-sensitive sensor element is additionally arranged in the single sensor housing. All of the abovementioned advantages are achieved in this way since, in addition to the angle of incidence, the intensity of the solar radiation and the pollutant gases present in the ambient air, the sensor can now also determine the atmospheric humidity. All of these measured values are used to enable the occupants of the motor vehicle to make use of said vehicle in a safe and comfortable manner. Atmospheric humidity may present a particular safety risk because it can cause the windows of the vehicle to mist up, and this can be effectively prevented by suitable actuation of the air-conditioning system.

In a subsequent development, a temperature-sensitive sensor element is additionally arranged in the single sensor housing. This development is also distinguished by all of the abovementioned advantages. The windows can be particularly effectively prevented from misting up if both the atmospheric temperature and the level of atmospheric moisture in the passenger compartment are known.

In one refinement, the printed circuit board is in the form of a flexible printed circuit board. Flexible printed circuit boards are inexpensive and lightweight components which can be easily adapted to the physical conditions in the sensor housing.

As an alternative to this, the printed circuit board is in the form of a punched metal part. Punched metal parts, also called leadframes, can be cost-effectively manufactured from metal sheets and can be effectively adapted to the physical conditions in the sensor housing by bending. Connection pins for making electrical contact between the sensor and the downstream electronics can be formed directly with the leadframe. This reduces costs, the number of method steps in the production process and time.

In a subsequent development, the electronic components which are arranged on the printed circuit board in the sensor housing process the electronic signals produced by the sensor elements to such an extent that the at least one connected controller which is supplied with information by the sensor requires a relatively low computational power and a relatively low storage capacity. If the signal processing takes place largely in the sensor itself, the controller, for example that for the air-conditioning system, has to execute fewer computational operations. The controller may thus be of more modest dimensions or fulfill other, additional tasks. Expediently preprocessed sensor signals may be stored in the controller with a considerably lower storage requirement than unprocessed raw signals.

Finally, it is advantageous if the electronic components which are arranged on the printed circuit board in the sensor housing process the electronic signals produced by the sensor elements to such an extent that said signals are available in the form of standardized signals to downstream electronics. With the ever increasing complexity of the signals which are processed in modern motor vehicles, the exchange of standardized signals between the individual devices in the motor vehicle is an effective way of avoiding errors during signal processing.

The invention permits numerous embodiments. One such embodiment will be explained with reference to the figures illustrated in the drawings, in which

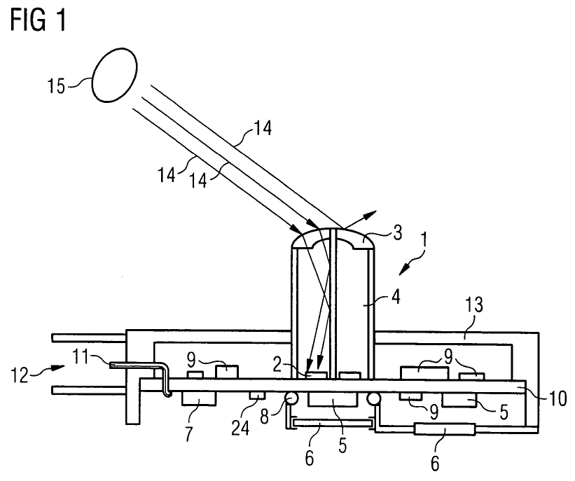

FIG. 1 shows a sensor for determining measured variables which are suitable for controlling an air-conditioning system and other apparatuses which influence the climate of an area,

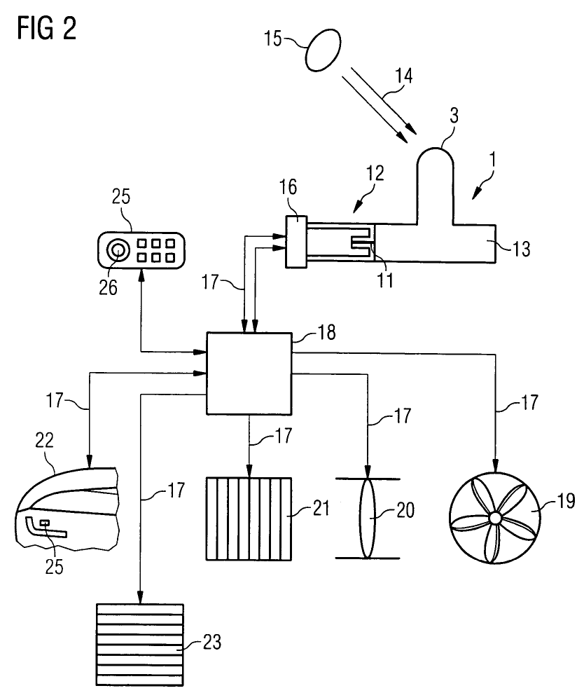

FIG. 2 shows a sensor for determining measured variables which are suitable for controlling an air-conditioning system and other apparatuses which influence the climate of an area, in conjunction with these devices,

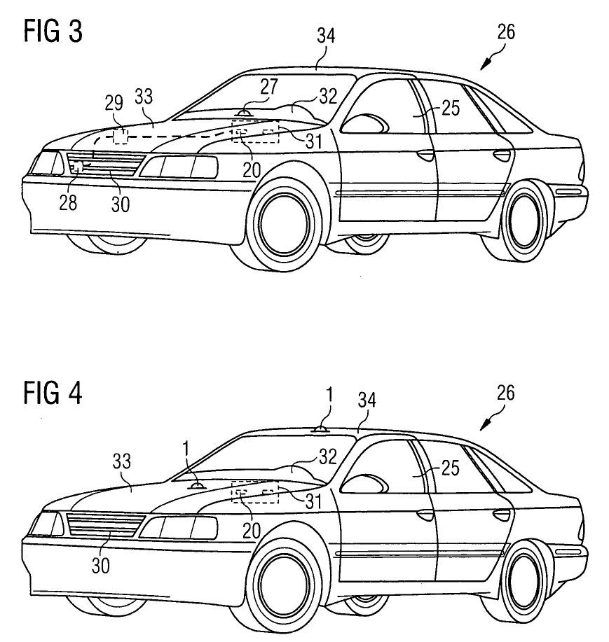

FIG. 3 shows a motor vehicle having sensors for detecting the position of the sun and for detecting pollutant gases in an arrangement according to the prior art, and

FIG. 4 shows a motor vehicle having the sensor for determining measured variables which are suitable for controlling an air-conditioning system and other apparatuses which influence the climate of an area.

FIG. 1 shows a sensor 1 for determining measured variables which are suitable for controlling an air-conditioning system 21 and other apparatuses 19, 20, 22, 23 which influence the climate of an area. A sensor 1 of this type is used in motor vehicles, where it may be positioned on the engine hood, in the roof region or on the dashboard, for example. The sensor 1 contains a printed circuit board 10 which may also be designed as a flexible printed circuit board or a leadframe and on which electronic components 9 and also different sensor elements 2, 5, 7, 24 are arranged. The light-sensitive sensor elements 2 illustrated here are generally photodiodes and are arranged at the end of at least one light duct 4. Rays of light 14 which are produced by a light source 15 enter the light ducts 4 by means of the input window 3. After multiple reflections, the rays of light 14 reach the light-sensitive sensor elements 2. The sensor for sensing the position of the sun which is formed from the input window 3, the light ducts 4, parts of the sensor housing 13, the electronic components 9 and the light-sensitive sensor elements 2 can detect the intensity of the rays of light 14 emitted by the light source 15 and determine the position of the light source 15 in relation to the sensor 1. The electrical signals which are produced by the light-sensitive sensor elements 2 are processed further in the electronic components 9 on the printed circuit board 10 and are made available to downstream electronics by means of connection pins 11 and the first connection element 12.

Furthermore, gas-sensitive sensor elements 5 are arranged on the printed circuit board 10. These gas-sensitive sensor elements 5 can detect, for example, the carbon dioxide concentration, the carbon monoxide concentration, the nitrogen oxide concentration and the concentration of malodorous organic gases. For their part, the signals produced by the gas-sensitive sensor elements 5 are processed by the electronic components 9 on the printed circuit board 10 and are made available to downstream electronics by means of the connection pins 11. If at least one of the abovementioned pollutant gases is detected by the gas-sensitive sensor element 5, the ventilation flaps in the motor vehicle may, for example, be set to the recirculation mode so that no pollutant gases or only small amounts of pollutant gases from the ambient air can enter the vehicle interior.

Correspondingly designed diaphragms 6 ensure that only the relevant components of the air-gas mixture flow over the gas-sensitive sensor elements 5. Furthermore, the gas-sensitive sensor elements 5 are designed and electronically connected in the circuit in such a way that they are particularly sensitive to certain gases. The seals 8 ensure that extraneous-gas components are not unintentionally fed to the individual gas-sensitive sensor elements 5.

In addition to the gas-sensitive sensor elements 5, moisture-sensitive sensor elements 7 and temperature-sensitive sensor elements 24 are also arranged on the printed circuit board 10. Their signals are also detected by the electronic components 9, processed and made available to the downstream electronics by means of the connection pins 11. For example, the windows of the vehicle can be prevented from misting up with a high level of atmospheric moisture if, as a result of the moisture and temperature measurement, the ventilation system is put into the fresh-air mode and the speed of the fan is increased when critical measured values are reached.

Overall, the sensor housing 13 comprises a large number of sensor elements 2, 5, 7, 24 which detect a large number of measured variables which are suitable for controlling an air-conditioning system 21 and other apparatuses 19, 20, 22, 23 which influence the climate of an area. The above-described advantages of the sensor 1 presented here are achieved by integrating the various sensor elements 2, 5, 7, 24 in a single sensor housing 13 and by using integrated electronics 9 to process the sensor signals which are produced.

FIG. 2 shows the sensor 1 for determining measured variables which are suitable for controlling an air-conditioning system 21 and other apparatuses 19, 20, 22, 23 which influence the climate of an area, in conjunction with these devices 19, 20, 21, 22, 23. By way of example, the sensor 1 is installed in a motor vehicle (not illustrated here) and the light-sensitive sensor elements 2, the gas-sensitive sensor elements 5, the moisture-sensitive sensor elements 7 and the temperature-sensitive sensor elements 24 on the printed circuit board 10 are arranged in the single sensor housing 13. The signals from the sensor elements 2, 5, 7, 24 are evaluated by the electronics 9 which are likewise integrated on the printed circuit board 10. A microprocessor may, for example, be advantageously used as the electronic component 9.

The preprocessed sensor signals, for example in standardized form, are made available to the downstream electronics by means of the at least one connection pin 11 in the first connection element 12. For this purpose, a second connection element 16 is inserted into the first connection element 12 and electrically connected to the latter. The electrical lines 17, which may also be in the form of a bus system, forward to the controller 18 the information acquired by the sensor and relating to the light intensity, the position of the sun, the pollutant gases present in the ambient air, the atmospheric humidity and the atmospheric temperature. This controller 18 can be equipped with a relatively low computational power and storage capacity on account of the signals which are expediently preprocessed by the sensor 1.

A vehicle occupant can communicate his individual wishes as regards the climatic conditions in the interior of the motor vehicle to the controller 18 by means of a control element 25 which may comprise, for example, a haptic rotary actuator 26 and a multiplicity of conventional switches. The wishes of the occupant of the motor vehicle are fulfilled to an optimum degree with the aid of the data acquired by the sensor 1 and relating to the light intensity, the position of the sun, the gas concentration, the atmospheric humidity and the ambient temperature. For this purpose, the controller 18 controls the air-conditioning system 21, the ventilation flaps 20, the electric window lifters 22 and the fans 19 which are present, for example. Further apparatuses 23 which influence the climate of an area can also be controlled in an optimum way by the controller 18.

Pleasant climatic conditions in the interior of the motor vehicle lead to safe and comfortable handling of the vehicle, which makes a substantial contribution to road safety. The sensor 1 presented here has many advantages which have already been described and have positive implications for the sensor manufacturer, the vehicle manufacturer and the driver of the vehicle.

FIG. 3 shows a motor vehicle 26 having sensors 27, 28 for detecting the position of the sun and for detecting pollutant gases in an arrangement according to the prior art. The sensor 27 for sensing the position of the sun is usually arranged on an instrument panel 32 in the passenger compartment 25 of a motor vehicle 26. The passenger compartment 25 of the motor vehicle 26 is separated from the engine compartment of the motor vehicle 26 by a partition wall 31. The engine compartment of the motor vehicle 26 is covered by the engine hood 33.

In addition to the sensor 27 for sensing the position of the sun, a pollutant-gas sensor 28 is arranged in the motor vehicle 26 behind the radiator grille 30. This pollutant-gas sensor 28 serves, for example, to detect the carbon dioxide concentration, the carbon monoxide concentration, the nitrogen oxide concentration or the concentration of malodorous organic gases. Conventional pollutant-gas sensors are heated to a very high temperature (approximately 700° C.) during operation in order to detect pollutant gases. On account of the high thermal losses, the gas-sensitive sensor elements 7 have to be arranged in a relatively large housing in order to prevent the sensor housing from being damaged. The signals which are produced by the pollutant-gas sensor 28 are generally supplied to a controller 29 which influences the ventilation of the passenger compartment 25 as a function of the acquired concentration of pollutant gases in the ambient air. If the pollutant-gas sensor 28 detects, for example, a high carbon dioxide concentration in the air surrounding the motor vehicle 26, the ventilation flaps 20 are closed and the passenger compartment 25 is no longer supplied with ambient air. This keeps the concentration of pollutant gas in the passenger compartment 25 low.

FIG. 4 shows the motor vehicle 26 known from FIG. 3, in which the sensor 1 for determining measured variables which are suitable for controlling an air-conditioning system 21 and other apparatuses 19, 20, 22, 23 which influence the climate in an area is now fitted. Favorable installation positions for this sensor 1 include, for example, on the engine hood 33 of the motor vehicle 26 or in the region of the motor-vehicle roof 34. The sensor 1 can be well irradiated by the light source 15 (generally the sun) and detect the pollutant gases in the external air both when on the engine hood 33 and on the roof 34 of the motor vehicle 26.

On account of their miniaturized configuration, modern gas-sensitive sensor elements 5 can be operated even at relatively low temperatures of approximately 270-440° C. The power electronics required for the gas-sensitive sensor elements 5 can be correspondingly economically dimensioned, as a result of which the outlay on circuitry for these sensor elements 5 can be considerably reduced. The electronics concept for evaluating the signals from the gas-sensitive sensor elements 5 can be adapted to the electronics concept for evaluating the light-sensitive sensor elements 2, as a result of which uniform evaluation electronics, generally having just a single microprocessor, are produced for the gas-sensitive sensor elements 5 and the light-sensitive sensor elements 2. The integration of the light-sensitive sensor elements 2 and the gas-sensitive sensor elements 5 in a single sensor housing results in the abovementioned advantages. Furthermore, moisture-sensitive sensor elements 7 and the temperature-sensitive sensor elements 24 may also be integrated in this single sensor housing 13. These sensor elements are also integrated in the uniform electronics concept and controlled and evaluated by the single microprocessor.

### LIST OF REFERENCE SYMBOLS

1 Sensor
2 Light-sensitive sensor element
3 Light duct
5 Gas-sensitive sensor element
6 Diaphragm
7 Moisture-sensitive sensor element
8 Seal
9 Electronic component
10 Printed circuit board-Leadframe
11 Connection pin
12 First connection element
13 Sensor housing
14 Ray of light
15 Light source
16 Second connection element
17 Electrical line-Bus
18 Controller
19 Fan
20 Ventilation flaps
21 Air-conditioning system
22 Electric window lifter
23 Further apparatus which influences the climate of an area
24 Temperature-sensitive sensor element
25 Passenger compartment
26 Motor vehicle
27 Sensor for sensing the position of the sun
28 Pollutant-gas sensor
29 Controller
30 Radiator grille
31 Detail of the partition wall
32 Instrument panel
33 Engine hood
34 Motor-vehicle roof

1-7. (canceled)

8. A sensor (1) for determining measured variables which are suitable for controlling an air-conditioning system (21) and other apparatuses (19, 20, 22, 23) which influence the climate of an area, being suitable for arrangement in a motor vehicle, the sensor comprising: a single sensor housing (13), and a printed circuit board (10) which is equipped with sensor elements (2, 5, 7, 24) for determining the measured variables; wherein the printed circuit board has electronic components (9) for processing electrical signals outputted by the sensor elements (2, 5, 7, 24), as a function of the measured variables; wherein at least one light-sensitive sensor element (2) and one gas-sensitive sensor element (5) are arranged in the one single sensor housing (13).

9. The sensor (1) as claimed in claim 8, wherein a moisture-sensitive sensor element (7) is additionally arranged in the single sensor housing (13).

10. The sensor (1) as claimed in claim 8, wherein a temperature-sensitive sensor element (24) is additionally arranged in the single sensor housing (13).

11. The sensor (1) as claimed in claim 8, wherein the printed circuit board (10) is in the form of a flexible printed circuit board.

12. The sensor (1) as claimed in claim 8, wherein the printed circuit board (10) is in the form of a punched metal part.

13. The sensor (1) as claimed in claim 8, wherein the electronic components (9), which are arranged on the printed circuit board (10) in the sensor housing (13), process the electronic signals produced by the sensor elements (2, 5, 7, 24) to such an extent that the at least one connected controller (18), which is supplied with information by the sensor (1), requires a relatively low computational power and a relatively low storage capacity.

14. The sensor (1) as claimed in claim 8, wherein the electronic components (9), which are arranged on the printed circuit board (10) in the sensor housing (13), process the electronic signals produced by the sensor elements (2, 5, 7, 24) to such an extent that said signals are available in the form of standardized signals to downstream electronics.
